(19) United States
(12) Patent Application Publication
(10) Pub. No.: US 2026/0253367 A1
(43) Pub. Date: Aug. 27, 2026

(54) ADAPTATION OF OPEN-VOCABULARY, MASK-BASED FRAME SEGMENTATION FOR NOVEL CONCEPTS

(71) Applicant: QUALCOMM Incorporated, San Diego, CA (US)

(72) Inventors: Shubhankar Mangesh BORSE, San Diego, CA (US); Varun RAVI KUMAR, San Diego, CA (US); Senthil Kumar YOGAMANI, San Diego, CA (US)

(21) Appl. No.: 19/063,127

(22) Filed: Feb. 25, 2025

(51) Int. Cl. G06V 10/26; G06V 10/40; G06V 10/774; G06V 10/82; G06V 20/70

(52) U.S. Cl. CPC G06V 10/26; G06V 10/40; G06V 10/774; G06V 10/82; G06V 20/70

(57) ABSTRACT

The present disclosure provide techniques for mask-based frame segmentation. A method may include obtaining, based on input, a first text label related to a first mask, generated by a neural network, for a first target region depicted in a first frame; and training, a text encoder of the neural network, to associate a text embedding of the first text label with a mask embedding of the first mask.

### INTRODUCTION

### Field of the Disclosure

Aspects of the present disclosure relate to techniques for mask-based frame segmentation.

### Description of Related Art

Frame segmentation is a computer vision technique that is used to partition a frame (e.g., image) into distinct regions or “segments.” The goal of frame segmentation is to simplify and represent a frame in a more understandable and analyzable manner, by separating different objects, areas, and/or structures within the frame, such as to enable computers to perceive and understand frame data in a manner that humans understand, view, and perceive. For example, with respect to a digital image, frame segmentation techniques may be used to divide the digital image into discrete groups of pixels, referred to as “segments.” Based on parsing the digital image's complex visual data into specifically-shaped segments, image segmentation may help to enable faster, more advanced image processing.

Frame segmentation techniques may range from simple, intuitive heuristic analysis to the use of machine learning (ML). For example, some frame segmentation techniques identify boundaries of object(s) and classify object(s) captured in a frame by analyzing frame features, such as color, brightness, or intensity, for each sample (e.g., pixel, point, etc.) in the frame (e.g., image, point cloud, etc.) to identify boundaries of object(s) and/or classify object(s) depicted in the frame. Some other frame segmentation techniques may leverage ML model(s), such as deep learning models employing complex neural networks for sophisticated pattern recognition, to perform similar task(s). As used herein, deep learning is a subset of ML that uses multilayered neural networks (e.g., artificial neural networks (ANNs), deep neural networks (DNNs), and/or convolutional neural networks (CNNs)) to simulate the complex decision-making power of the human brain. For example, the neural networks may include multiple layers of interconnected nodes, each building on a previous layer to refine and optimize prediction of the network.

“Mask-based frame segmentation” is one example frame segmentation technique that uses a “segmentation mask” to define a target region of interest within a frame. A “segmentation mask” (simply referred to herein as a “mask”) may refer to a binary image (e.g., made up of 0s and 1s, where 1s may be used to represent a target region of interest) that highlights specific samples (e.g., pixels, points, etc.) within a frame, such as to identify and isolate a target region for further analysis. In certain aspects, in addition to generating a mask, mask-based frame segmentation may further include mask classification, where a text label is assigned to each sample within a generated mask, indicating what the samples in the target region represent in the frame. In certain aspects, mask generation and classification may be used for “semantic segmentation” to segment and classify all instances of a target region (e.g., an object) belonging to a same class (e.g., segment and label all instances of cars in a frame, segment and label every instance of a person in a frame, etc.). In certain other aspects, mask generation and classification may be used for “instance segmentation” to partition and label individual target regions (e.g., individual objects) in a frame (e.g., segment a first person and label as “Jane Doe,” segment a second person and label as “John Smith,” etc.). For example, unlike semantic segmentation, which classifies each sample (e.g., a pixel, a point, etc.) of a frame into broad categories (e.g., classes) without distinguishing between different instances of the same class, instance segmentation may provide a more granular understanding by differentiating between individual instances and assigning a unique label to each.

Mask-based frame segmentation has many applications in various fields, including, but not limited to, medical imaging, autonomous vehicles, robotics, agriculture, and gaming. For example, in medical imaging, mask-based frame segmentation may be used to identify, mask/isolate, and label organs, tissues, and/or lesions within medical images (e.g., such as magnetic resonance imagings (MRIs), ultrasounds, X-rays, and/or computed tomography (CT) scans) to enable healthcare professionals to analyze and quantify these areas for health monitoring, diagnosis, and/or treatment planning, among other tasks. As another example, in autonomous driving, mask-based frame segmentation may be used to enable a vehicle to navigate safely and efficiently on the road. Specifically, mask-based frame segmentation techniques may help the vehicle to accurately identify (e.g., detect, mask, and label) obstacles such that they can be avoided, identify and separate different lanes, and/or differentiate between different types of objects and areas in an environment surrounding the vehicle, including road(s), sidewalk(s), building(s), and/or vegetation. As another example, in robotics, mask-based frame segmentation may enable a robot to identify and separate different objects within a scene, using one or more masks, such as to enable the robot to identify a specific object of interest and navigate towards that object, among other actions.

### SUMMARY

Certain aspects provide a method for mask-based frame segmentation, such as by an apparatus. The method may include obtaining, based on input, a first text label related to a first mask, generated by a neural network, for a first target region depicted in a first frame; and training, a text encoder of the neural network, to associate a text embedding of the first text label with a mask embedding of the first mask.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system for mask-based frame segmentation.

FIG. 2A depicts example training of a text encoder to associate a novel text label with a mask generated for a target region in a frame.

FIG. 2B depicts example low-rank adaptation (LoRA) adapter-based fine-tuning techniques for fine-tuning a text encoder.

FIG. 3 depicts an example artificial intelligence (AI) architecture.

FIG. 4 depicts an example artificial neural network (ANN).

FIG. 5 depicts an example method for mask-based frame segmentation.

FIG. 6 depicts aspects of an example apparatus.

### DETAILED DESCRIPTION

Aspects of the present disclosure provide apparatuses, methods, processing systems, and computer-readable mediums for a mask-based frame segmentation system that is capable of adapting to novel concepts in real-time, such as to expand its segmentation vocabulary.

The ability to perceive and segment both known and unknown target regions (e.g., target objects) in an environment may be important for many real-world applications, like autonomous driving, robot sensing and navigation, human object interaction, augmented reality (AR), healthcare, and/or the like. Some traditional mask-based segmenters, however, may only be able to localize pre-defined semantic concepts within a specific dataset. Specifically, these segmenters may be designed to segment and label target regions in a frame based only on a limited set of categories (e.g., limited set of labels) explicitly defined during their training for performing mask-based segmentation. Accordingly, these segmenters may be unable to recognize target regions in a frame that do not belong to one of the predefined categories. This presents a technical problem in the real world, where objects and/or backgrounds of all different kinds, shapes, categories, etc. may be encountered, and thus may need to segmented and labeled, such as for various computer vision applications.

Accordingly, in recent years, there has been increasing attention towards open-vocabulary, mask-based segmentation (simply referred to herein as “open-vocabulary segmentation”). An open-vocabulary segmentation model may be capable of segmenting a target region in a frame, using a mask, and assigning a label, to this target region, from a large, open set of categories (e.g., labels). The set of categories may include one or more categories that were not used to train the model (e.g., to perform mask-based segmentation). As an illustrative example, the training data used to train an open-vocabulary segmentation model may include a pre-defined semantic label of “traffic light” but not “light source.” However, the open-vocabulary segmentation model may still be capable of segmenting and labeling a “light source” depicted in a frame when instructed to perform such segmentation, such as based on obtaining an input free-form text description.

Some existing open-vocabulary approaches leverage vision-language models (VLMs) to align visual information from a frame with textual descriptions, such as in a vision-text features space, to effectively expand the number and range of categories that may be segmented. For example, VLMs are models that are trained on vast datasets comprising image-text pairs, allowing them to learn the intricate relationships between visual elements and their corresponding descriptions. Accordingly, VLMs may recognize and understand a wide variety of objects and scenes, even those that are not explicitly present in their training data. This makes VLMs particularly useful for applications needing open-vocabulary segmentation, where previously unseen target regions (e.g., unseen objects) need to be identified and classified. One example VLM includes “CLIP” (contrastive language-image pre-training), a model developed by OpenAI® to recognize a wide variety of visual concepts in images and associate them with their respective labels. Large vision models (LVMs) and large language models (LLMs) are a subset of ML models that make up VLMs. For example, VLMs may combine text and visual inputs.

In some cases, a VLM encoder (e.g., a text encoder, such as a CLIP encoder) may be combined with a mask-based segmentation model. For instance, a mask-based segmentation model may excel in spatial understanding for segmentation, while a VLM encoder may be useful enhanced semantic understanding. Thus, by combining the VLM encoder and the mask-based segmentation model into a unified model, the model may be capable of achieving improved segmentation performance compared to other models configured to perform similar segmentation tasks, especially for novel (e.g., unseen) concepts (e.g., open-vocabulary categories) depicted in a frame.

Despite the aforementioned benefits of using VLMs, and more specifically, VLM encoders, for segmentation, VLM encoders may fail to enable a segmentation solution that is capable of segmenting everything. For example, VLM enocders may learn to understand new concepts, such as for segmentation, by leveraging their knowledge of similar concepts encountered during training. That is, VLM encoders may be effective in segmenting concepts that have partially been seen before, and may be limited in their ability to enable the segmentation of concepts that are rare, unlike, and/or unrelated to concepts that the VLM encoder is exposed to during training. For example, a VLM encoder may not be able to recognize, such as for segmentation and classification, (1) special types of objects, including special traffic signs and/or lights, (2) categories of emergency vehicles (e.g., such as where the VLM has not been trained to distinguish between different categories of emergency vehicles and a language model is not able to accurately distinguish between the different categories given the text the language model has been trained on), (3) user-specific (e.g., user-defined) objects (e.g., “My Car”) for a particular user, (4) unusual or rare objects, and/or the like. In these cases, there exists a need to perform additional training to expand the segmentation vocabulary of the VLM encoder. The additional training may occur offline to align at least the VLM encoder with modules of the mask-based segmentation model, including for example, a frame encoder and a mask decoder, such as to enable the VLM encoder and the mask-based segmentation model to perform mask generation and classification for one or more novel (e.g., previously-unseen) concepts. This training presents a technical problem given the high costs (e.g., with respect to time, computational power, and resources) associated with training each of these modules. For example, for on-device personalization, training may need to occur on-device, which may involve the use of a network signal processor (NSP) chip, such as of a vehicle or smartphone, for example. This compute infrastructure may be different than training on a cluster of graphics processing units (GPUs).

Accordingly, techniques for efficiently and effectively enabling mask-based segmentation models to learn novel concepts for segmentation (e.g., to learn to segment novel target regions, novel objects, etc.) may be desired. As used herein, “novel concepts” may refer to rare concepts, unusual concepts, concepts that are unlike and/or unrelated to concepts used during training, and/or the like. Example novel concepts may include a new target region (e.g., new object), a new class, a new category, and/or the like. Additionally, novel concepts may include personalized concepts (e.g., such as a user's specific vehicle).

Certain aspects described herein overcome the aforementioned technical problems and provide a technical benefit to the field of computer vision. Specifically, certain aspects described herein provide a system for mask-based frame segmentation that is capable of adapting to novel concepts in real-time, such as to expand its segmentation vocabulary. For example, the system may utilize on-device training, such that a text encoder of the system learns, for example, in real-time, a new text label (e.g., associated with a novel concept) that the text encoder has never seen, or partially seen, before. The new text label may be based on input provided to a device (e.g., such as an edge device or mobile phone), such as by a user of the device, where the system is deployed for operation. The text encoder may be trained directly on the device where the input is received, as opposed to relying on cloud servers and/or centralized systems. This additional training may enable the text encoder to learn a relationship between the text label and specific visual elements that are associated with the text label, such that the text encoder is able to recognize and label similar visual elements during subsequent segmentation.

As an illustrative example, a perception system of a vehicle (e.g., an autonomous vehicle) may be used to sense and build a reliable and detailed representation of an environment surrounding the vehicle (e.g., a “perception output”). The perception system may perform various computer vision tasks to generate the perception output, including at least mask-based frame segmentation. That is, sensor data, such as a frame from at least one sensor installed at, or on, the vehicle, may be obtained and processed to partition and label target region(s) (e.g., representing one or more objects in the environment) depicted in the frame. The perception system may display this frame, which has been segmented to highlight target region(s) in the frame, to a user of the vehicle. In this example, the frame may include a unique road sign not commonly seen in most areas (e.g., a sign warning drivers about kangaroos crossing the road), which the perception system may be unable to classify. Thus, the frame displayed to a user may lack segmentation information for this specific road sign. To enable the system to partition and classify this road sign, the user may provide the system with information about the road sign, such as a text label of “Kangaroo Crossing Road Sign.” Based on this input, on-device training may be used to train a text encoder of the system to align an embedding of a mask generated for the road sign with a text embedding of the text label “Kangaroo Crossing Road Sign,” such that the system is able to segment and classify this new object, for example, for subsequent segmentation. As used herein, an “embedding” may refer to a numerical representation of data (e.g., text, images, audio, etc.) that captures its relevant qualities in a way that machines and/or machine learning (ML) algorithms can process.

Although the above example illustrates the use of the techniques described herein for adapting a mask-based frame segmentation system to partition and classify rare or unique concepts, in some other examples, the techniques may be similarly used to enable the system to partition and classify user-defined objects. For example, the techniques may be used to personalize the system for a user, such that the system is able to accurately recognize the user's specific house (e.g., segment and label their house in a frame), the user's specific car (e.g., segment and label their car in a frame), the user's wife, husband, daughter, and/or son (e.g., segment and label the user's family members by name), and/or the like.

It is noted that while training is generally a costly operation, primarily due to the high resources usage needed for performing complex calculations, on-device training may be limited to the available resources and energy constraints of specific devices where the training is occurring. Thus, to enable on-device training of a mask-based frame segmentation system implemented on a mobile device, such as an edge device, aspects described here may leverage adapter-based fine-tuning techniques. For example, one or more adapters (e.g., small, trainable modules crafted to be both lightweight and modular) may be integrated at various points within the ML architecture (e.g., a neural network) of the text encoder. Rather than fine-tuning the entire system, these adapter(s) may be selectively fine-tuned to facilitate the enhancement of the text encoder to learn novel concepts for segmentation. As such, training may be focused on a limited subset of the text encoders parameters, which may help to reduce the computational resources and/or power generally needed to perform such fine-tuning. This approach may not only help to alleviate the costs generally associated with traditional model fine-tuning but may also offer a method for mitigating “catastrophic forgetting” by the text encoder. “Catastrophic forgetting” may refer to a phenomenon where an ML model loses or forgets previously-acquired knowledge as the ML model is trained on new data. This phenomenon may occur due to the limitations of the training process, as model training may prioritize recent data and/or tasks at the expense of earlier data. As a result, the ML model's representations of certain concepts and/or knowledge may degrade and/or may become replaced by newer information, leading to a loss of overall performance and/or accuracy, such as on segmentation tasks that generally require an understanding of

In addition to the aforementioned advantages associated with the use of adapter-based fine-tuning techniques, the system and techniques for mask-based frame segmentation described herein may provide one or more other various beneficial technical effects and/or advantages. For example, the system and techniques for mask-based frame segmentation may enable improved segmentation capability and accuracy. The improved segmentation capability may be attributable to the ability of the system to adapt, in real-time, to novel concepts that the system may have been previously unable to classify during segmentation. The improved segmentation accuracy may be attributable to the ability of the system to learn personalized, rare, and/or unusual text labels. Accordingly, more target regions depicted in a frame, including rare and/or unusual target regions, may be identified, segmented, and classified. Further, more precise classification labels (e.g., such as personalized text labels) may be assigned to segmented target regions in a frame for improved segmentation performance, and in some cases, user experience with the system. In certain aspects, more accurate frame segmentation may help to improve downstream applications, which rely on this segmentation for performing various tasks.

### Example System for Mask-based Frame Segmentation

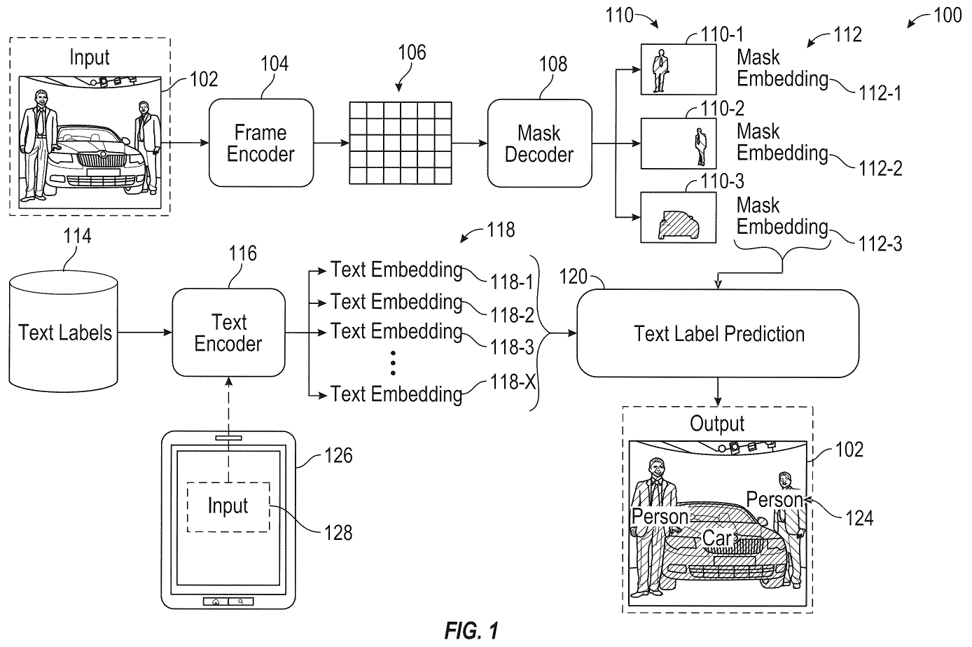

FIG. 1 depicts an example system 100 configured to perform mask-based frame segmentation. For example, system 100 may be used to generate one or more masks, and their corresponding label(s), for one or more target regions in a frame. The mask(s) generated by system 100 may include instance segmentation mask(s) and/or semantic segmentation mask(s) for the target region(s) in the frame. In certain aspects, the mask(s) generated by system 100 may include mask(s) for target region(s) depicted in a frame, for which system 100 has been adapted, such as in real-time, to segment and classify. For example, system 100 may be capable of training a text encoder 116 of system 100 to learn the relationship between a text label, not previously learned by text encoder 116, and features of a target region associated with the text label, to improve, such as in real-time, the segmentation and classification performance of system 100. For example, using on-device training of text encoder 116, system 100 may expand its segmentation vocabulary to enable system 100 to perform segmentation and classification of additional and/or user-defined target regions. As used herein, “on-device” training may refer to “online training,” or more specifically, training of text encoder 116 of system 100 after system 100 has been deployed on a device (e.g., a mobile device), such as for operation (e.g., performing mask-based frame segmentation). Alternatively, “offline training” may refer to training that occurs prior to exporting system 100 on a chip of a device and/or on a remote cloud, such as where data is sent by the chip of a device.

For example, as shown in FIG. 1, system 100 includes a frame encoder 104, a mask decoder 108, and a text encoder 116, which may be used to perform mask-based frame segmentation for a frame 102.

Frame 102 may capture one or more objects in a scene, such as a dynamic real-world scene (e.g., a scanned environment), for a first time period (e.g., time T=0). For example, the frame 102 may include depictions of object(s) in the scene during the first time period. In certain aspects, frame 102 may comprise a two-dimensional (2D) frame or 2D representation, such as a 2D image (simply referred to herein as an “image”). For example, an image sensor, such as a camera, may be used to produce the image of the frame 102. The image of the frame 102 may include samples, such as pixels, in 2D space for a scanned environment. At least a subset of the pixels may be associated with one or more objects in the scanned environment. In certain other aspects, frame 102 may comprise a three-dimensional (3D) frame or a 3D representation, such as a 3D point cloud (simply referred to herein as “a point cloud”). For example, a 3D sensor, such as a light detection and ranging (LiDAR) sensor, may be used to produce the point cloud of the frame 102. The point cloud of the frame 102 may include a collection of samples, such as points, in 3D space for the scene. At least a subset of the points may be associated with one or more objects in the scanned environment.

In the example shown in FIG. 1, frame 102 is an image captured by an image sensor. The frame 102 may include depictions of at least two individuals standing next to a vehicle, with one individual on each side of the vehicle, in a car dealership during a first time period. The frame 102 may have been captured by an image sensor in the car dealership during the first time period. Although aspects herein are described with respect to the frame 102 comprising an image, in certain other aspects, other frame data (e.g., such as point cloud data) may be considered for mask-based frame segmentation by system 100.

System 100 may begin performing mask-based frame segmentation based on frame encoder 104, of system 100, extracting features 106 from frame 102. For example, frame encoder 104 may be used to transform frame 102 into image features 106, or “image embeddings,” which are numerical representations of frame 102 encoded into a lower-dimensional vector representation. In other words, image feature extraction performed by the frame encoder 104 may be used to extract distinct features 106 in frame 102 and represent them as vectors in a lower-dimensional space. The extracted features 106 may provide semantic information about frame 102 by capturing low-level visual features, such as edges, and textures, and/or higher-level semantic information, such as objects, in frame 102. The extracted features 106 may include meaningful features from frame 102, thereby allowing models, such as mask decoder 108 described in detail below, to interpret the content of frame 102 more easily.

In certain aspects, frame encoder 104 may be used to extract multi-scale features 106 from frame 102. A “multi-scale feature 106” extracted by frame encoder 104 may refer to a feature 106 extracted from frame 102 at multiple resolution levels, meaning frame encoder 104 may process frame 102 at multiple scales based on applying additional downsampling and/or upsampling to capture information at varying resolutions/sizes of frame 10. This is different than single-scale feature extraction where frame 102 may be analyzed at a single resolution to extract features from frame 102.

Mask decoder 108 may take features 106, extracted from frame 102, and translate them into semantically meaningful mask(s) 110 for frame 102. For example, when performing semantic segmentation, mask decoder 108 may process features 106 to classify each pixel into a predefined class (e.g., car, person, etc.) and generate a mask 110 for each class. Alternatively, when performing instance segmentation, mask decoder 108 may process features 106 to classify each pixel into a predefined class, as well as differentiate between different instances belonging to the same class. Thus, mask decoder 108 may generate a mask 110 for each instance segmented in frame 102.

In this example, mask decoder 108 processes features 106 and generates three masks 110-1, 110-2, and 110-3 and three corresponding mask embeddings 112-1, 112-2, and 112-3, respectively. Mask 110-1 may include a mask associated with the person depicted on the left side of the vehicle in frame 102. Mask 110-2 may include a mask associated with the person depicted on the right side of the vehicle in frame 102. Mask 110-3 may include a mask associated with the vehicle in frame 102. Mask embedding 112-1 may comprise a representation of mask 110-1 as a first vector of features, mask embedding 112-2 may comprise a representation of mask 110-2 as a second vector of features, and mask embedding 112-3 may comprise a representation of mask 110-3 as a third vector of features. Each mask embedding 112 may numerically represent spatial information for its corresponding mask 110 in a vector space.

In certain aspects, frame encoder 104 and mask decoder 108 may comprise components of the Segment Anything Model (SAM) developed by Meta AI®. SAM is a promptable, foundation model, specializing in image segmentation, allowing it to accurately locate one or more objects depicted within an image. As used herein, a “foundation model” may refer to a pre-trained deep neural network that forms the backbone for various downstream computer vision tasks, such as object detection, object classification, etc. SAM may be capable of generating segmentation masks (e.g., such as masks 110 shown in FIG. 1), for a wide variety of objects, and, in some cases, based on a variety of visual prompts (e.g., provided as input). This means that users can provide visual prompts to the model in various forms, such as via clicks, boxes, scribbles, or any other visual input indicating what to segment in an image. This versatility may allow users to specify the segmentation task according to their needs. Thus, the frame encoder 104 and mask decoder 108 of SAM may be designed to generate mask(s) 110 for frame 102, used to outline or cover desired target region(s) (e.g., object(s), area(s), etc.) in frame 102 based on visual prompt(s) provided to SAM.

System 100 may further include a text encoder 116 configured to generate text label(s) 124 for one or more of the masks 110 generated by system 100. For example, text encoder 116 may be combined with frame encoder 104 and mask decoder 108 to form a unified model (e.g., of system 100) for mask generation and classification. Text encoder 116 may be used to assign a text label 124 to each mask 110 that text encoder 116 has previously seen (e.g., such as during training) and/or that is similar to other mask(s) and text label(s) used to train text encoder 116. In particular, text encoder 116 may be trained to classify masks 110, for target regions depicted in frame 102, based on pre-defined text labels 114 used to train text encoder, or labels similar to text labels 114. Text encoder may perform such classification/labeling based on generating a text embedding 118 for each text label 114 (e.g., shown, in FIG. 1, as text embeddings 118-1 through 118-X for X text lables 114). A “text embedding 118” may refer to a vector representation of a piece of text (e.g., a text label 114, such as a word, a phrase, a sentence, etc.) used to capture its meaning and context. A text embedding 118 may map such text into a vector space, where other pieces of text are represented as vectors. Similar pieces of text may have similar text embeddings 118, and thus may be positioned close together in the vector space, meaning their numerical representations may be alike. Text encoder 116 may be trained to align each mask embedding 112 with its corresponding text embedding 118, such as to generate a text label 124 for each generated mask 110 (e.g., during text label prediction 120).

In certain aspects, text encoder 116 is a text encoder of CLIP developed by OpenAI®, also referred to as a CLIP encoder. In certain aspects, text encoder 116 is the encoder part of a text-to-text transfer transformer (T5) model.

For the example shown in FIG. 1, text encoder 116 may have been previously trained to identify and classify masks associated with at least text labels 114 “person” and “car.” Thus, text encoder 116 may generate at least text embedding 118-1 for text label 114 “person” and text embedding 118-2 for text label 114 “car.” Further, text encoder 116 may associate mask embedding 112-1 with text embedding 118-1, and thus generate a text label 124 of “person” for mask 110-1. Text encoder 116 may also associate mask embedding 112-2 with text embedding 118-1, and thus generate a text label 124 of “person” for mask 110-2. Lastly, text encoder 116 may associate mask embedding 112-3 with text embedding 118-2, and thus generate a text label 124 of “car” for mask 110-3.

In certain aspects, system 100 may output, for display, frame 102 with masks 110 and text labels 124 (e.g., as shown as the output in FIG. 1). In certain aspects, a user interface may be used to display frame 102 with masks 110 and text labels 124, such as to a user.

In certain aspects, a user may desire to personalize the mask-based frame segmentation performed by system 100. That is, a user may define one or more text labels for one or more target regions that the user desires system 100 to be able to segment and classify. For example, in FIG. 1, a user may personalize a text label for the specific vehicle shown in frame 102, such that system 100 labels this vehicle, when performing segmentation for a frame 102 depicting the specific vehicle, as “My car.” To enable system 100 to learn this text label, such that system 100 associates this text label with the specific vehicle during subsequent segmentation, system 100 may be adapted according to aspects described herein.

In certain other aspects, a user may define one or more text labels for one or more target regions that the system 100 was unable to segment and/or classify. For example, in FIG. 1, system 100 may be unable to segment and classify the vehicle in frame 102. To enable system 100 to learn the text label “car”, such that system 100 associates this text label with the vehicle in other frames during subsequent segmentation, system 100 may be adapted according to aspects described herein.

For example, input 128 may be provided to system 100. Input 128 may include text input, audio input, and/or the like specifying a new text label that system 100 is expected to understand for mask generation and classification. The text label may comprise a label for a target region (e.g., an object) that system 100 (1) was not previously trained to recognize and classify, and/or (2) is not similar to a target region that system 100 was previously trained to recognize and classify. For example, the text label may be associated with (1) special types of objects, including special traffic signs and/or lights, (2) categories of emergency vehicles, (3) user-specific (e.g., user-defined) objects (e.g., “My Car”) for a particular user, (4) unusual or rare objects, and/or the like. In certain aspects, input 128 may be obtained by system 100 based on a user providing the input 128 to system 100 via a user interface of a device 126 (e.g., a mobile device, edge device, etc.) where system 100 is implemented.

Based on obtaining input 128, system 100 may train text encoder 116 to associate the text label associated with input 128 with a mask for a particular target region, such that text encoder 116 is able to recognize and label similar target regions with the text label during subsequent segmentation. In certain aspects, training text encoder 116 based on the text label may involve freezing the mask generation process of system 100 (e.g., via frame encoder 104 and mask decoder 108), and training only the text encoder 116 to align a mask embedding 112 (e.g., generated for a particular target region in frame 102) with a text embedding 118 of the text label (e.g., associated with input 128). In this way, backpropagation may need less activation memory due to the fact that it does not need to update gradients for frame encoder 104 and/or mask decoder 108. In certain aspects, training only the text encoder 116 to align a mask embedding 112 with a text embedding 118 may be performed using a cosine similarity reduction loss function. In certain aspects, training only the text encoder 116 to align a mask embedding 112 with a text embedding 118 may be performed based on determining the mean square error (MSE) loss between the embeddings (e.g., mask embedding 112 and text embedding 118).

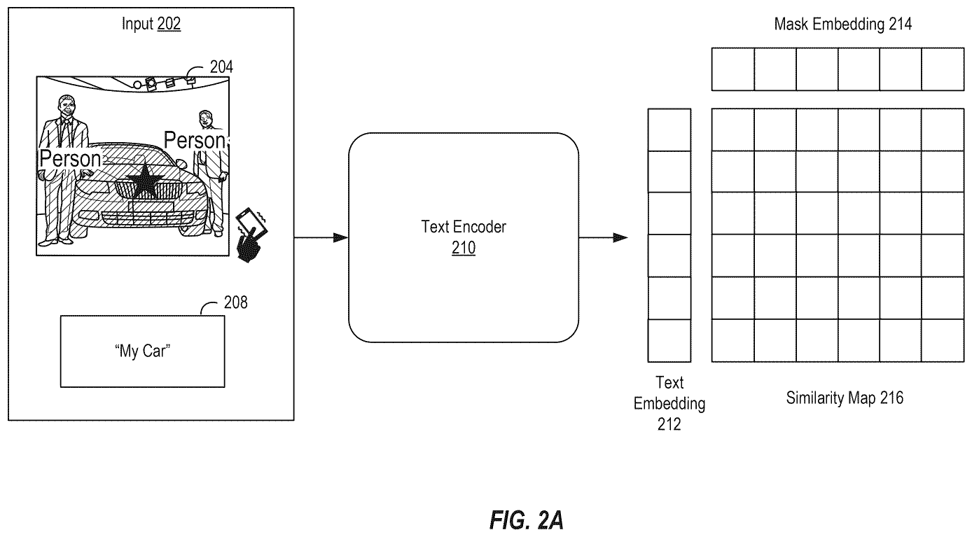

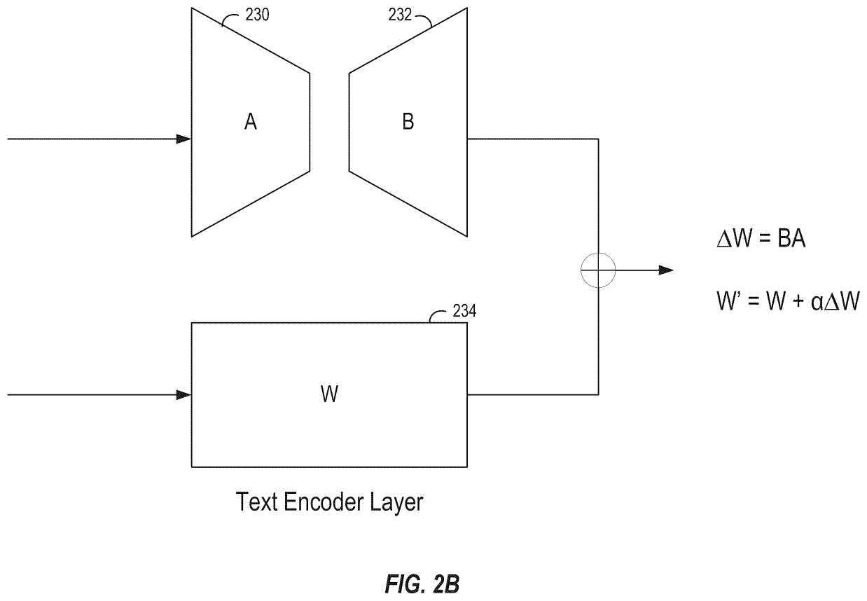

In certain aspects, training text encoder 116 based on the text label may involve performing on-device training, or more specifically, training text encoder 116 on a device 126 where input 128 (e.g., from a user) is received. In certain aspects, adapter-based fine-tuning techniques may be leveraged to train text encoder 116 based on the text label. Additional details related to training text encoder 116 for a novel text label, associated with input 128, are provided in FIGS. 2A and 2B.

For example, as shown in FIG. 2A, input 202 obtained by a system configured to perform mask-based frame segmentation (e.g., such as system 100 in FIG. 1) may include visual input 204 and text input 208. Text input 208 may include a novel text label, for which the system is currently unable to perform mask-based frame segmentation, such as to segment and classify a target region depicted in a frame that is associated with the text label. Visual input 204 may indicate the target region that is to be associated with the novel text label. In certain aspects, text input 208 may be obtained by the system based a user typing on a keyboard and/or translating audio input from a user into text input 208. In certain aspects, visual input 204 may be obtained by the system based on a user providing visual prompts in various forms, such as via click, boxes, scribbles, and/or the like.

In the example shown in FIG. 2A, based on providing input 202, a user may desire that the system learns to segment and classify the particular vehicle shown in the frame, included in visual input 204, as “My Car” instead of simply assigning the generic label of “car” to the vehicle. Specifically, the user may want to personalize the segmentation that is performed by the system, such that the system recognizes the user's car when it is depicted in a frame processed by the system.

Based on obtaining input 202, text encoder 210 (e.g., an example of text encoder 116 in system 100 of FIG. 1) may be trained to associate a text embedding 212 of the text label “My Car” (e.g., associated with input 202) with a mask embedding 214 of a mask associated with the user's particular vehicle (e.g., identified based on visual input 204). Text embedding 212 may comprise a vector representation of the text label, which is used to capture its meaning and context. Mask embedding 214 may comprise a vector representation of the mask associated with the user's particular vehicle, which is used to numerically represent spatial information for the mask. In certain aspects, mask embedding 214 may be a mask that was previously generated for the particular vehicle, such as based on using the frame encoder 104 and mask decoder 108 depicted and described above with respect to FIG. 1.

In certain aspects, text encoder 210 may be trained to align text embedding 212 and mask embedding 214 in a shared similarity map 216. As used herein, a “shared similarity map” may refer to a 2D pairwise matrix representing the similarity between each generated mask and each text category (e.g., each text category that may be prompted). A similarity map may be similar to an affinity matrix. The shared similarity map 216 may enable text encoder 210 to learn the relationship between the text label and mask associated with text embedding 212 and mask embedding 214, respectively, such as based on the proximity of text embedding 212 and mask embedding 214 in the shared similarity map 216. Learning this relationship may enable text encoder 210 to associate this text label with the mask when it is generated for the vehicle, such as when the vehicle is depicted in a frame that is subsequently processed by the mask-based frame segmentation system.

As mentioned above, training text encoder 210 to recognize and classify a target region associated with the text label may be performed using on-device training. Specifically, the text encoder 210 may be trained directly on the device where the input 202 is received, as opposed to relying on cloud servers and/or centralized systems. To reduce resource and/or power consumption and thus allow for the on-device training, and/or improve the efficiency of such training, certain aspects described herein may utilize one or more adapters. For example, adapter(s) may be added between layers of the text encoder 210 (e.g., a neural network) to enable the text encoder 210 to adapt to new tasks, including the segmentation and classification of target region(s) depicted in a frame that are associated with novel text label(s) (e.g., provided as input 202), such as without forgetting previously-learned tasks (e.g., segmentation and classification based on previously-learned text labels). For example, adapter(s) may be added as a parallel branch to the attention layers of the text encoder 210. Tuning of the text encoder 210 with adapter(s) may involve adding a small number of new parameters to the text encoder 210 (e.g., “a small number of new parameters” may refer to the adapter(s)), which are trained on the downstream segmentation task using the novel text label. When tuning the text encoder using the adapter(s), the weights of the text encoder 210 may be untouched, while the new adapter layer(s) are initialized at random.

In certain aspects, the adapter(s) used for on-device training of text encoder 210 may include low-rank adaptation (LoRA) adapters. FIG. 2B depicts example LoRA adapter fine-tuning of the text encoder 210. LoRA adapter fine-tuning may occur to fine tune LoRA adapters over linear layers of text encoder 210. In certain aspects, the LoRA adapters may be attached to the linear layers, of text encoder 210, as a parallel branch. As used herein, a “linear layer” of text encoder 210 (also commonly referred to as a “fully connected layer”) may refer to a layer of a neural network (e.g., of text encoder 210) having neurons that are connected to every neuron in a previous layer in the neural network. A linear layer of text encoder 210 may be used to perform a linear transformation on some input to produce an output, such as based on applying a weight matrix (e.g., weight matrix 234, or matrix W, shown in FIG. 2B). In some cases, fine-tuning LoRA adapters over the linear layers of text encoder 210 may help to reduce the number of learnable parameters to 1% of the original parameters of text encoder 210.

As shown in FIG. 2B, fine-tuning LoRA adapters over a linear layer of text encoder 210 may include representing the weight updates to text encoder 210 with two smaller matrices 230, 232, shown as matrices A and B in FIG. 2B, respectively, through low-rank decomposition. Matrices 230 and 232 (e.g., matrices A and B) may be trained to adapt to the new data while keeping the overall number of changes to text encoder 210 low. The original weight matrix 234 for a layer of text encoder 210, shown as matrix W in FIG. 2B, may remain frozen and may not receive any further adjustments when training the LoRA adapters. The original weight matrix 234 (e.g., matrix W) may be updated based on calculating the product of matrices 230 and 232 (e.g., product of matrix A and matrix B) and adding this to the original weight matrix 234.

For example, for LoRA adapter fine-tuning of text encoder 210 (e.g., a layer of text encoder 210), a weight update (W′) may be defined as:

$${W}^{′} = W + αΔ W$$

$$where :$$

$$Δ W = A \cdot B$$

and variable W represents the original weight matrix 234, variable A represents matrix 230 (e.g., matrix A), variable B represents matrix 232 e.g., matrix B), operation · represents multiplication, and variable α represents a scaling hyperparameter applied to the output of the low-rank adaptation. For example, variable α may control the extent to which the output of the adapted layer of text encoder 210 is allowed to influence the original output of the layer being adapted. Specifically, variable α may be used to control the impact of the low-rank adaptation on the output of the layer of text encoder 210.

As an illustrative example, original weight matrix 234, matrix W, may have dimensions (Cᵢₙ×Cₒᵤₜ). Matrix 230 (e.g., matrix A) may have dimensions (Cᵢₙ×R) while matrix 232 (e.g., matrix B) may have dimensions (R×Cₒᵤₜ), where R<<min(Cᵢₙ, Cₒᵤₜ). Matrix 230 (e.g., matrix A) multiplied with matrix 232 (e.g., matrix B) may result in a matrix AB (or BA) (e.g., A·B=ΔW) with dimensions (Cᵢₙ×Cₒᵤₜ). A LoRA adapter may be attached to original weight matrix 234, matrix W, as W'=W+αΔW=W+α(A·B). This may be done such that the original information in original weight matrix 234, matrix W, is not changed, and matrix 230 (e.g., matrix A) and matrix 232 (e.g., matrix B) are stored.

In certain aspects, every attention block of text encoder 210 may include three linear layers. In certain aspects, the three linear layers may include three multi-layer perceptrons (MLPs), namely: to_k (before generating a “key”), to_v (before generating a “value”), and to_q (before generating a “query”). Every MLP may have a LoRA layer that is parallel to it. For example, the LoRA adapters may be attached to the to_k, to_q, and to_v linear layers as a parallel branch. There may be three LoRAs for each attention block, and multiple attention blocks in text encoder 210. To train a LoRA (e.g., the A and B matrices), the original linear layers to_k, to_q, to_v may be frozen (e.g., not tuned), and the A and B matrices may be learned. In certain aspects, the training may be performed using a cosine similarity reduction loss function. In certain aspects, the training may be performed based on determining an MSE loss.

In certain other aspects, the adapter(s) used for on-device training of text encoder 210 may include one or more Fourier low-rank adaptation (FouRA) adapters; one or more weight-decomposed low-rank adaptation (DoRA) one or more parameter-efficient fine-tuning (Peft) adapters; or one or more orthogonal fine-tuning (oft) adapters.

### Example AI System for Mask-based Frame Segmentation

Certain aspects described herein may be implemented, at least in part, using some form of AI, e.g., the process of using an ML model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as an object detection system in autonomous driving.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

### Example AI System for Mask-based Frame Segmentation

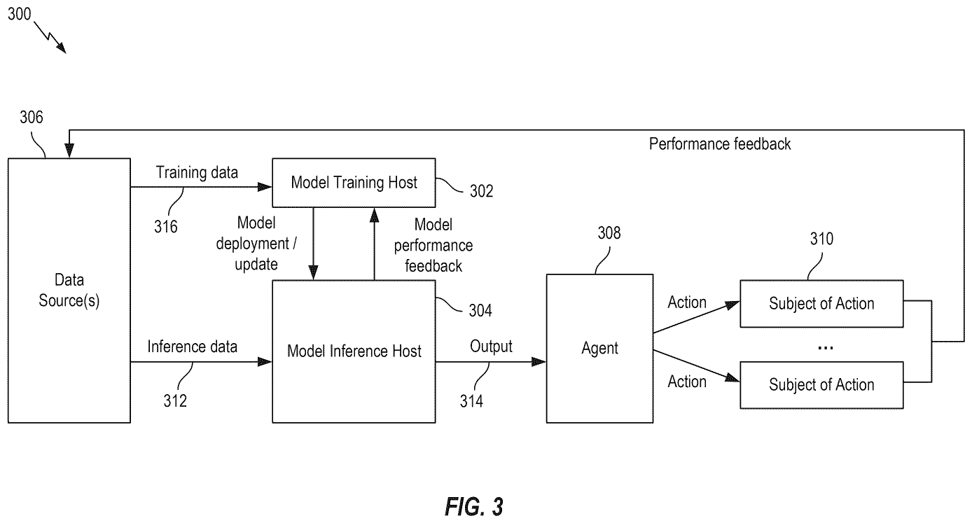

FIG. 3 is a diagram illustrating an example AI architecture 300 that may be used to implement the ML model(s) and mask-based frame segmentation techniques described in this disclosure. As illustrated, the architecture 300 includes multiple logical entities, such as a model training host 302 for training the ML model(s) for mask-based frame segmentation, a model inference host 304 for running inference using the trained ML Model(s) for mask-based frame segmentation and/or other downstream computer vision task(s), data source(s) 306 providing training and inference data, and an agent 308 that utilizes the model(s)′ output. This AI architecture could be used to enable the disclosed frame segmentation techniques in various ML applications.

The model inference host 304, in the architecture 300, is configured to run the trained ML model(s) based on inference data 312 provided by data source(s) 306. The model inference host 304 may produce an output 314 (e.g., detected objects, scene representations) based on the inference data 312, which is then provided as input to the agent 308. The model inference host 304 utilizes the frame segmentation techniques described in this disclosure to generate accurate mask(s) for one or more target regions in a frame, thereby enabling downstream tasks such as object tracking and motion planning, among others.

The agent 308 may be an element or entity that utilizes the output of the ML model(s) hosted by the model inference host 304. The agent 308 could be a software component, a hardware accelerator, or a system that leverages the frame segmentation(s), and further mask(s), produced by the model(s) for various downstream tasks such as autonomous navigation, collision avoidance, or driver assistance systems.

For example, if the output 314 from the model inference host 304 includes masks for various objects in a scene, the agent 308 may be an object detection module and/or a motion planning module that generates safe and efficient trajectories for a robot. That is, in robotics, segmentation mask(s), such as output by the ML model(s) described herein, may be used to enable a robot to discern and navigate around objects in their environment.

After receiving the output 314 from the model inference host 304, the agent 308 may determine how to utilize it. For instance, if the agent 308 decides to use the output 314, it may apply it to the subject of the action 310, which represents the data being processed or enhanced. In some cases, the agent 308 and subject of action 310 may be tightly integrated.

The data sources 306 may be configured to collect data used as training data 316 for the model training host 302 to train the frame segmentation ML model(s). The data sources 306 may also provide inference data 312 to the model inference host 304. This data could come from various entities and may include the subject of action 310. For example, for training a frame segmentation model, the data sources 306 may collect synchronized sensor data from cameras, LiDAR, radar, and other sensors mounted on vehicles. The model training host 302 can then monitor the model(s)′ performance on this data to determine if retraining or fine-tuning with the frame segmentation model is necessary to improve accuracy. In some cases, the agent 308 and the subject of action 310 are the same entity.

The data sources 306 may be configured for collecting data that is used as training data 316 for training the frame segmentation ML model(s). The data sources 306 may also provide inference data 312 (also referred to as input data) for feeding the trained model(s) during inference. In particular, the data sources 306 may collect data relevant to the frame segmentation task at hand, such as user input having different modalities, sensor data from various modalities, or the like. This data may come from various sources, including the subject of action 310, which represents the data being processed by the model(s). The collected data is provided to the model training host 302 for training and fine-tuning the object detection model. For example, after the subject of action 310 (e.g., sensor data with known object positions) is processed by the model(s), the output 314 (e.g., detected objects and scene representations) may be compared to ground truth data to evaluate the model(s)' performance. If the output 314 is not sufficiently accurate, this performance feedback may be used by the model training host 302 to further train the model using the disclosed object detection techniques, aiming to improve detection accuracy and robustness. The updated model(s) may then be deployed to the model inference host 304.

In certain aspects, the model training host 302 may be deployed at or with the same or a different entity than that in which the model inference host 304 is deployed. For example, to offload model training processing, which can impact the performance of the model inference host 304, the model training host 302 may be deployed at a model server as further described herein. Further, in some cases, training and/or inference may be distributed amongst devices in a decentralized or federated fashion.

In some aspects, the frame segmentation ML model(s) may be deployed at or on a computing device for enhancing the performance of downstream computer visions tasks, such as objection detection and related tasks. For example, a model inference host, such as model inference host 304 in FIG. 3, may be deployed at or on the computing device for running the mask-based frame segmentation ML model(s), such as to improve the detection accuracy and object tracking in dynamic environments.

In some other aspects, frame segmentation ML model(s) are deployed at or on an embedded system or mobile device for enabling efficient on-device inference. More specifically, a model inference host, such as model inference host 304 in FIG. 3, may be deployed at or on the embedded system or mobile device for running the model(s) to obtain the mask-based frame segmentations while meeting resource constraints.

### Example AI Model

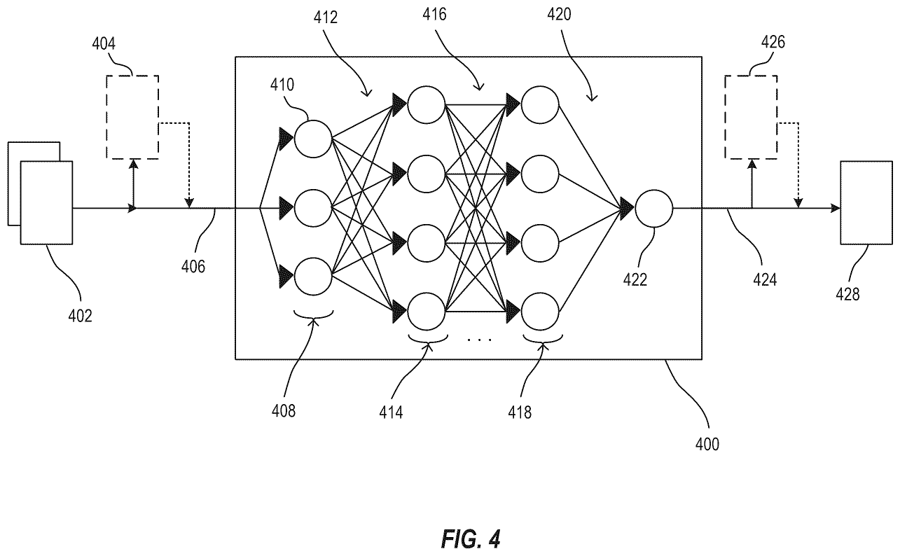

FIG. 4 is an illustrative block diagram of an example artificial neural network (ANN) 400 that can be used to implement the mask-based frame segmentation techniques described in this disclosure.

ANN 400 may receive input data 406, which may include one or more bits of data 402, pre-processed data output from pre-processor 404 (optional), or some combination thereof. Here, data 402 may include sensor data from various modalities (e.g., cameras, LiDAR, radar), such as one or more frames, user prompt(s), simulated prompt(s), or the like, e.g., depending on the stage of development and/or deployment of ANN 400. Pre-processor 404 may, for example, process all or a portion of data 402 to synchronize sensor inputs, apply calibration parameters, or normalize the data. In some implementations, pre-processor 404 may add additional data to data 402, such as time stamps or sensor metadata. Further, in certain aspects, data 402 may include input associated with a text label, such as user-provided input.

ANN 400 includes at least one first layer 408 of artificial neurons 410 (e.g., perceptrons) to process input data 406 and provide resulting first layer output data via edges 412 to at least a portion of at least one second layer 414. Second layer 414 processes data received via edges 412 and provides second layer output data via edges 416 to at least a portion of at least one third layer 418. Third layer 418 processes data received via edges 416 and provides third layer output data via edges 420 to at least a portion of a final layer 422 including one or more neurons to provide output data 424. All or part of output data 424 may be further processed in some manner by (optional) post-processor 426. Thus, in certain examples, ANN 400 may provide output data 428 that is based on output data 424, post-processed data output from post-processor 426, or some combination thereof. Post-processor 426 may be included within ANN 400 in some other implementations. Post-processor 426 may, for example, process all or a portion of output data 424 which may result in output data 428 being different, at least in part, to output data 424, e.g., as result of data being changed, replaced, deleted, etc. In some implementations, post-processor 426 may be configured to add additional data to output data 424, such as domain-specific post-processing or adaptation. In this example, second layer 414 and third layer 418 represent intermediate or hidden layers that may be arranged in a hierarchical or other like structure. Although not explicitly shown, there may be one or more further intermediate layers between the second layer 414 and the third layer 418.

The structure and training of artificial neurons 410 in the various layers may be tailored to specific requirements of an application, such as multi-grid sensor fusion for object detection and tracking. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process to learn domain-invariant representations. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 312 in FIG. 3) across different domains. Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 400 and a number of layers and a number of artificial neurons in each layer, as well as selecting activation functions, a loss function, training processes, etc., to enable domain generalization and adaptation. Once an initial model has been designed, training of the model may be conducted using training data from multiple domains. Training data may include one or more datasets within which ANN 400 may detect, determine, identify or ascertain patterns that are consistent across domains. Training data may represent various types of information, including written, visual, audio, environmental context, operational properties, etc., from different domains. During training, parameters of artificial neurons 410 may be changed, such as to minimize or otherwise reduce a loss function or a cost function that measures the model's performance across domains. A training process may be repeated multiple times to fine-tune ANN 400 with each iteration to improve its domain generalization capability.

Various ANN model structures are available for consideration in the context of domain generalization and adaptation. For example, in a feedforward ANN structure each artificial neuron 410 in a layer receives information from the previous layer and likewise produces information for the next layer. In a convolutional ANN structure, some layers may be organized into filters that extract domain-invariant features from data (e.g., training data and/or input data). In a recurrent ANN structure, some layers may have connections that allow for processing of data across time, such as for processing information having a temporal structure, such as time series data forecasting across domains.

In an autoencoder ANN structure, compact representations of data may be processed and the model trained to predict or potentially reconstruct original data from a reduced set of features that capture domain-invariant patterns. An autoencoder ANN structure may be useful for tasks related to dimensionality reduction and data compression in a domain-agnostic manner.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models in a domain-adaptive way. For example, a GAN could be used to generate realistic training data for a new domain to improve the domain generalization of another model.

A transformer ANN structure makes use of attention mechanisms that may enable the model to process input sequences in a parallel and efficient manner while capturing long-range dependencies and domain-specific patterns. An attention mechanism allows the model to focus on different parts of the input sequence at different times based on their relevance to the task and domain. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences in a domain-adaptive way. The output of a transformer ANN structure may be obtained by applying a linear transformation to the output of a final attention layer. A transformer ANN structure may be of particular use for tasks that involve sequence modeling, or other like processing, across different domains.

Another example type of ANN structure, is a model with one or more invertible layers. Models of this type may be inverted or “unwrapped” to reveal the input data that was used to generate the output of a layer, which can be useful for understanding how the model adapts to different domains.

Other example types of ANN model structures that can be used for domain generalization and adaptation include fully connected neural networks (FCNNs) and long short-term memory (LSTM) networks.

ANN 400 or other ML models may be implemented in various types of processing circuits along with memory and applicable instructions therein, for example, as described herein with respect to FIG. 3. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models that can perform object detection.

### Example Method for Mask-based Frame Segmentation

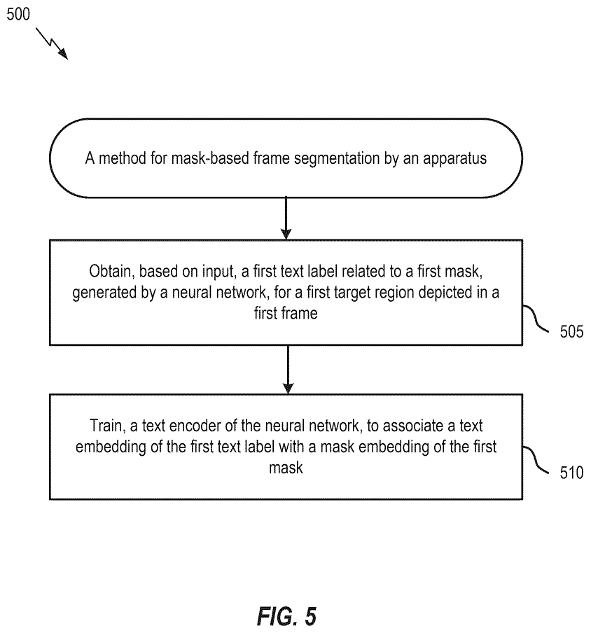

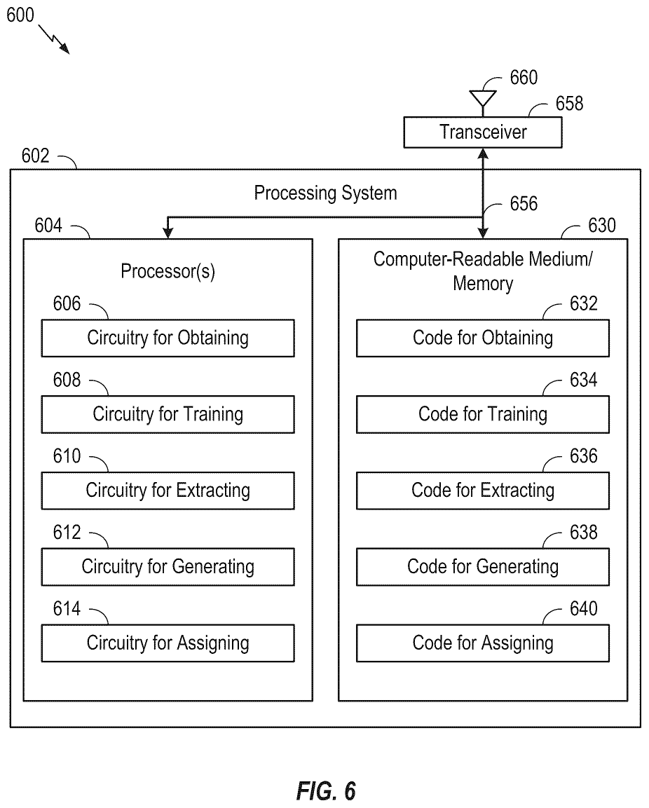

FIG. 5 depicts an example method 500 for mask-based frame segmentation. In certain aspects, method 500, or any aspect related to it, may be performed by an apparatus, such as apparatus 600 of FIG. 6, which includes various components operable, configured, or adapted to perform the method 500. Apparatus 600 is described below in further detail.

Method 500 begins at block 505 with obtaining, based on input, a first text label related to a first mask, generated by a neural network, for a first target region depicted in a first frame.

Method 500 then proceeds to block 510 with training, a text encoder of the neural network, to associate a text embedding of the first text label with a mask embedding of the first mask.

In certain aspects, the neural network further comprises a frame encoder and a mask decoder, wherein the frame encoder and the mask decoder are trained together to perform mask segmentation; and training the text encoder comprises training the text encoder without training the frame encoder and the mask decoder.

In certain aspects, training the text encoder comprises: training one or more adapters within one or more layers of the text encoder.

In certain aspects, the one or more adapters comprise: one or more low-rank adaptation (LoRA) adapters; one or more Fourier low-rank adaptation (FouRA) adapters; one or more weight-decomposed low-rank adaptation (DoRA); one or more parameter-efficient fine-tuning (Peft) adapters; or one or more orthogonal fine-tuning (oft) adapters.

In certain aspects, method 500 further includes, before obtaining the first text label: extracting a plurality of features from the first frame; generating, by the neural network, one or more masks for one or more target regions in the first frame, the one or more target regions including the first target region, the one or more masks including the first mask; and assigning, by the neural network, a respective text label to each of at least one mask of the one or more masks.

In certain aspects, the at least one mask comprises the first mask; and the first text label is different than the respective text label assigned to the first mask.

In certain aspects, assigning the respective text label to each of the at least one mask comprises assigning the respective text label to each of the at least one mask without assigning a text label to the first mask.

In certain aspects, method 500 further includes, after training the text encoder to associate the text embedding with the mask embedding: extracting a plurality of features from a second frame depicting at least the first target region; generating, by the neural network, a second mask for the first target region, in the second frame; and assigning, by the neural network, the first text label to the second mask.

In certain aspects, method 500 further includes, after training the text encoder to associate the text embedding with the mask embedding: obtaining a prompt corresponding to the first text label; extracting a plurality of features from a second frame, the second frame depicting at least the first target region; generating, by the neural network, a second mask for the first target region, in the second frame, based on the prompt; and assigning, by the neural network, the first text label to the second mask.

In certain aspects, the apparatus is deployed on a mobile device. In certain aspects, training the text encoder comprises training the text encoder after the apparatus is deployed on the mobile device (e.g., training occurs online).

In certain aspects, the apparatus is deployed on a mobile device. In certain aspects, obtaining the first text label comprises obtaining the input via a user interface of the mobile device.

Note that FIG. 5 is just one example of a method, and other methods including fewer, additional, or alternative operations are possible consistent with this disclosure.

### Example Apparatus for Frame Segmentation

FIG. 6 depicts aspects of an example apparatus 600. Apparatus 600 may be implemented in various ways. For example, apparatus 600 may be implemented within on-site, remote, or cloud-based processing equipment. As another example, apparatus 600 may be implemented on a computing device or a mobile device, such as an edge device.

The apparatus 600 includes a processing system 602, which may be coupled to a transceiver 658 (e.g., a transmitter and/or a receiver). The transceiver 658 is configured to transmit and receive signals for the apparatus 600 via an antenna 660, such as the various signals as described herein. The processing system 602 may be configured to perform processing functions for the apparatus 600, including processing signals received and/or to be transmitted by the apparatus 600.

The processing system 602 includes one or more processors 604. Generally, processor(s) 604 may be configured to execute computer-executable instructions (e.g., software code) to perform various functions, as described herein. The one or more processors 604 are coupled to a computer-readable medium/memory 630 via a bus 656. In certain aspects, the computer-readable medium/memory 630 is configured to store instructions (e.g., computer-executable code) that when executed by the one or more processors 604, enable and cause the one or more processors 604 to perform the method 500 described with respect to FIG. 5, or any aspect related to it, including any operations described in relation to FIGS. 1, 2A, 2B and/or 5. Note that reference to a processor performing a function of the apparatus 600 may include one or more processors performing that function of the apparatus 600, such as in a distributed fashion.

In the depicted example, computer-readable medium/memory 630 stores code (e.g., executable instructions), including code for obtaining 632, code for training 634, code for extracting 636, code for generating 638, and code for assigning 640. Processing of the code 632-640 may enable and cause the apparatus 600 to perform the method 500 described with respect to FIG. 5, or any aspect related to it=.

The one or more processors 604 include circuitry configured to implement (e.g., execute) the code stored in the computer-readable medium/memory 630, including circuitry for obtaining 606, circuitry for training 608, circuitry for extracting 610, circuitry for generating 612, and circuitry for assigning 614. Processing with circuitry 606-614 may enable and cause the apparatus 600 to perform the method 500 described with respect to FIG. 5, or any aspect related to it.

More generally, means for communicating, receiving, or obtaining may include the transceiver 658 and/or antenna 660 of the apparatus 600 in FIG. 6, and/or one or more processors 604 of the apparatus 600 in FIG. 6. Means for training, extracting, generating, and/or assigning may include one or more processors 604 of the apparatus 600 in FIG. 6.

Apparatus 600 is just one example, and other configurations are possible. For example, in alternative aspects, aspects described with respect to apparatus 600 may be omitted, added, or substituted for alternative aspects.

### Example Clauses

Implementation examples are described in the following numbered clauses:

Clause 1: A method for mask-based frame segmentation by an apparatus, comprising: obtaining, based on input, a first text label related to a first mask, generated by a neural network, for a first target region depicted in a first frame; and training, a text encoder of the neural network, to associate a text embedding of the first text label with a mask embedding of the first mask.

Clause 2: The method of Clause 1, wherein: the neural network further comprises a frame encoder and a mask decoder, wherein the frame encoder and the mask decoder are trained together to perform mask segmentation; and training the text encoder comprises training the text encoder without training the frame encoder and the mask decoder.

Clause 3: The method of any one of Clauses 1-2, wherein training the text encoder comprises: training one or more adapters within one or more layers of the text encoder.

Clause 4: The method of Clause 3, wherein the one or more adapters comprise: one or more low-rank adaptation (LoRA) adapters; one or more Fourier low-rank adaptation (FouRA) adapters; one or more weight-decomposed low-rank adaptation (DoRA); one or more parameter-efficient fine-tuning (Peft) adapters; or one or more orthogonal fine-tuning (oft) adapters.

Clause 5: The method of any one of Clauses 1-4, further comprising, before obtaining the first text label: extracting a plurality of features from the first frame; generating, by the neural network, one or more masks for one or more target regions in the first frame, the one or more target regions including the first target region, the one or more masks including the first mask; and assigning, by the neural network, a respective text label to each of at least one mask of the one or more masks.

Clause 6: The method of Clause 5, wherein: the at least one mask comprises the first mask; and the first text label is different than the respective text label assigned to the first mask.

Clause 7: The method of any one of Clauses 5-6, wherein assigning the respective text label to each of the at least one mask comprises assigning the respective text label to each of the at least one mask without assigning a text label to the first mask.

Clause 8: The method of any one of Clauses 1-7, further comprising, after training the text encoder to associate the text embedding with the mask embedding: extracting a plurality of features from a second frame depicting at least the first target region; generating, by the neural network, a second mask for the first target region, in the second frame; and assigning, by the neural network, the first text label to the second mask.

Clause 9: The method of any one of Clauses 1-8, further comprising, after training the text encoder to associate the text embedding with the mask embedding: obtaining a prompt corresponding to the first text label; extracting a plurality of features from a second frame, the second frame depicting at least the first target region; generating, by the neural network, a second mask for the first target region, in the second frame, based on the prompt; and assigning, by the neural network, the first text label to the second mask.

Clause 10: The method of any one of Clauses 1-9, wherein: the apparatus is deployed on a mobile device; and training the text encoder comprises training the text encoder after the apparatus is deployed on the mobile device.

Clause 11: The method of any one of Clauses 1-10, wherein: the apparatus is deployed on a mobile device; and obtaining the first text label comprises obtaining the input via a user interface of the mobile device.

Clause 12: One or more apparatuses, comprising: one or more memories comprising executable instructions; and one or more processors configured to execute the executable instructions and cause the one or more apparatuses to perform a method in accordance with any one of Clauses 1-11.

Clause 13: One or more apparatuses configured for object detection, comprising: one or more memories; and one or more processors, coupled to the one or more memories, configured to cause the one or more apparatuses to perform a method in accordance with any one of Clauses 1-11.

Clause 14: One or more apparatuses configured for object detection, comprising: one or more memories; and one or more processors, coupled to the one or more memories, configured to perform a method in accordance with any one of Clauses 1-11.

Clause 15: One or more apparatuses, comprising means for performing a method in accordance with any one of Clauses 1-11.

Clause 16: One or more non-transitory computer-readable media comprising executable instructions that, when executed by one or more processors of one or more apparatuses, cause the one or more apparatuses to perform a method in accordance with any one of Clauses 1-11.

Clause 17: One or more computer program products embodied on one or more computer-readable storage media comprising code for performing a method in accordance with any one of Clauses 1-11.

Clause 18: One or more apparatuses configured for object detection, comprising: a processing system that includes one or more processors and one or more memories coupled with the one or more processors, the processing system configured to cause the one or more apparatuses to perform a method in accordance with any one of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system that includes one or more processors and one or more memories coupled with the one or more processors, the processing system configured to cause the apparatus to:
obtain, based on input, a first text label related to a first mask, generated by a neural network, for a first target region depicted in a first frame; and
train, a text encoder of the neural network, to associate a text embedding of the first text label with a mask embedding of the first mask.

2. The apparatus of claim 1, wherein:
the neural network further comprises a frame encoder and a mask decoder, wherein the frame encoder and the mask decoder are trained together to perform mask segmentation; and
to cause the apparatus to train the text encoder, the processing system is configured to cause the apparatus to train the text encoder without training the frame encoder and the mask decoder.

3. The apparatus of claim 1, wherein to cause the apparatus to train the text encoder, the processing system is configured to cause the apparatus to:
train one or more adapters within one or more layers of the text encoder.

4. The apparatus of claim 3, wherein the one or more adapters comprise:
one or more low-rank adaptation (LoRA) adapters;
one or more Fourier low-rank adaptation (FouRA) adapters;
one or more weight-decomposed low-rank adaptation (DoRA)
one or more parameter-efficient fine-tuning (Peft) adapters; or
one or more orthogonal fine-tuning (oft) adapters.

5. The apparatus of claim 1, wherein, before the first text label is obtained, the processing system is configured to cause the apparatus to:
extract a plurality of features from the first frame;
generate, by the neural network, one or more masks for one or more target regions in the first frame, the one or more target regions including the first target region, the one or more masks including the first mask; and
assign, by the neural network, a respective text label to each of at least one mask of the one or more masks.

6. The apparatus of claim 5, wherein:
the at least one mask comprises the first mask; and
the first text label is different than the respective text label assigned to the first mask.

7. The apparatus of claim 5, wherein to cause the apparatus to assign the respective text label to each of the at least one mask, the processing system is configured to cause the apparatus to assign the respective text label to each of the at least one mask without assigning a text label to the first mask.

8. The apparatus of claim 1, wherein, after the text encoder is trained to associate the text embedding with the mask embedding, the processing system is configured to cause the apparatus to:
extract a plurality of features from a second frame depicting at least the first target region;
generate, by the neural network, a second mask for the first target region, in the second frame; and
assign, by the neural network, the first text label to the second mask.

9. The apparatus of claim 1, wherein, after the text encoder is trained to associate the text embedding with the mask embedding, the processing system is configured to cause the apparatus to:
obtain a prompt corresponding to the first text label;
extract a plurality of features from a second frame, the second frame depicting at least the first target region;
generate, by the neural network, a second mask for the first target region, in the second frame, based on the prompt; and
assign, by the neural network, the first text label to the second mask.

10. The apparatus of claim 1, wherein:
the apparatus is deployed on a mobile device; and
to cause the apparatus to train the text encoder, the processing system is configured to cause the apparatus to train the text encoder after the apparatus is deployed on the mobile device.

11. A method for mask-based frame segmentation by an apparatus, comprising:
obtaining, based on input, a first text label related to a first mask, generated by a neural network, for a first target region depicted in a first frame; and
training, a text encoder of the neural network, to associate a text embedding of the first text label with a mask embedding of the first mask.

12. The method of claim 11, wherein:
the neural network further comprises a frame encoder and a mask decoder, wherein the frame encoder and the mask decoder are trained together to perform mask segmentation; and
training the text encoder comprises training the text encoder without training the frame encoder and the mask decoder.

13. The method of claim 11, wherein training the text encoder comprises:
training one or more adapters within one or more layers of the text encoder.

14. The method of claim 13, wherein the one or more adapters comprise:
one or more low-rank adaptation (LoRA) adapters;
one or more Fourier low-rank adaptation (FouRA) adapters;
one or more weight-decomposed low-rank adaptation (DoRA)
one or more parameter-efficient fine-tuning (Peft) adapters; or
one or more orthogonal fine-tuning (oft) adapters.

15. The method of claim 11, further comprising, before obtaining the first text label:
extracting a plurality of features from the first frame;
generating, by the neural network, one or more masks for one or more target regions in the first frame, the one or more target regions including the first target region, the one or more masks including the first mask; and
assigning, by the neural network, a respective text label to each of at least one mask of the one or more masks.

16. The method of claim 15, wherein:
the at least one mask comprises the first mask; and
the first text label is different than the respective text label assigned to the first mask.

17. The method of claim 15, wherein assigning the respective text label to each of the at least one mask comprises assigning the respective text label to each of the at least one mask without assigning a text label to the first mask.

18. The method of claim 11, further comprising, after training the text encoder to associate the text embedding with the mask embedding:
extracting a plurality of features from a second frame depicting at least the first target region;
generating, by the neural network, a second mask for the first target region, in the second frame; and
assigning, by the neural network, the first text label to the second mask.

19. The method of claim 11, further comprising, after training the text encoder to associate the text embedding with the mask embedding:
obtaining a prompt corresponding to the first text label;
extracting a plurality of features from a second frame, the second frame depicting at least the first target region;
generating, by the neural network, a second mask for the first target region, in the second frame, based on the prompt; and
assigning, by the neural network, the first text label to the second mask.

20. One or more non-transitory computer-readable media comprising executable instructions that, when executed by one or more processors of an apparatus, cause the apparatus to perform operations comprising:
obtaining, based on input, a first text label related to a first mask, generated by a neural network, for a first target region depicted in a first frame; and
training, a text encoder of the neural network, to associate a text embedding of the first text label with a mask embedding of the first mask.
